(19) United States
(12) Patent Application Publication
(10) Pub. No.: US 2008/0083461 A1
(43) Pub. Date: Apr. 10, 2008

(54) FLUID EXCHANGE APPARATUS WITH LOCKING FLOW ALIGNMENT DEVICE

(76) Inventor: JAMES P. VIKEN, Eden Prairie, MN (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 11/868,249

(22) Filed: Oct. 5, 2007

Related U.S. Application Data
(60) Provisional application No. 60/850,149, filed on Oct. 5, 2006.

(51) Int. Cl. F16K 31/02; F04B 49/22; F17D 3/01; F17D 3/10

(52) U.S. Cl. 137/384.6; 137/15.01; 137/551; 137/565.11

(57) ABSTRACT

A system and method for exchanging used hydraulic fluid with fresh hydraulic fluid in an accessed hydraulic fluid system. The system includes a fluid exchange assembly, a flow-aligning valve assembly and a locking mechanism. The locking mechanism allows the pressure of the fresh fluid being conducted to the hydraulic fluid system to be increased by a boost pump beyond the nominal pressure of the used fluid being conducted from the fluid system to the valve assembly during an exchange procedure. Together the boost pump and locking mechanism provide for an efficient exchange of fluids within a hydraulic system, particularly those hydraulic systems exhibiting relatively low flow.

### RELATED APPLICATIONS

This application claims the benefit of U.S. Provisional Application No. 60/850,149, filed Oct. 5, 2006.

### FIELD OF THE INVENTION

The present invention relates to hydraulic fluid exchanging devices, and more particularly to an apparatus for achieving and maintaining proper fluid flow alignment between a fluid exchange device and an accessed hydraulic fluid system, particularly those fluid systems having low flow, such as certain types of vehicular automatic transmissions.

### BACKGROUND OF THE INVENTION

The market for fluid exchanging equipment for vehicular hydraulic fluid systems, such as power steering and automatic transmissions, has undergone relatively rapid expansion. Many such devices have been recently developed. One unresolved problem has been the inherent need for an inexpensive fluid exchange system which is simple to operate and which supports desirable features of some known, more complex and expensive exchange units, such as an automatic bypass mechanism and such as the automatic fluid flow alignment mechanism as disclosed in U.S. Pat. No. 5,472,064 and U.S. Pat. No. 6,330,934 and U.S. Pat. No. 6,779,633 to Viken, each patent being incorporated by reference herein.

An unresolved need remains for a fluid exchanger capable of servicing automatic transmissions having low fluid flow such as certain Ford Explorers, Ford pick-up type trucks, and other Ford vehicles, and some Geo Metros and other small foreign designed vehicles, and certain Toyotas and the like.

A need remains for simple and inexpensive fluid exchanger which can be interconnected to a low flow hydraulic circuit, such as that of a vehicular automatic transmission, and which has features of automatic fluid flow alignment, automatic bypass established at the completion of the fluid exchange, and which has the ability to apply low pressure to the fluid being discharged from the accessed hydraulic circuit while pumping the fresh fluid into that hydraulic circuit. Such a device would need to accomplish these objects without disrupting the normal fluid flow patterns of the accessed hydraulic circuit while preferably maintaining equalized flow rates between the used fluid being discharged from the hydraulic circuit and the fresh fluid being pumped into that circuit.

### SUMMARY OF THE INVENTION

A fluid exchange device in accordance to the present invention includes a multi-port valve assembly and a lock component. The valve assembly is in fluid communication with an accessed hydraulic system via a pair of flexible conduits. The valve assembly controls directions of fluid flow within the device during an exchange procedure. A boost pump may be utilized to increase a flow of fluid through the exchange device. In one embodiment, the lock component restrains a portion of the valve assembly during the exchange procedure in order to maintain proper fluid flow while the boost pump is activated.

Addressing the deficiencies of the conventional art, a fluid exchange device of the present invention resolves unmet needs in an efficient, cost effective manner. The fluid exchange device is relatively easy to operate and adaptable to a variety of automatic transmissions or hydraulic circulating systems and the like of vehicles, machinery, aircraft and equipment. In one embodiment, a fluid exchange device in accordance with the present invention includes a locking mechanism connected to an automatic flow-aligning valve assembly which allows a boost pump to be operated. A bypass device for removing a portion of the exchange device from the accessed hydraulic circuit at the completion of the fluid exchange is also provided. The fluid exchange system of the present invention can be utilized while the accessed hydraulic circuit is operational and without any change in the fluid volume contained in the accessed hydraulic system. The locking mechanism allows the fluid exchange system to include a boost pump to either the used fluid conduit on the fresh fluid conduit or both without disrupting the operation of the automatic fluid alignment assembly which is controlled at the onset by the fluid pressure provided by the accessed hydraulic system alone. As such, the fluid pressure of the accessed hydraulic system determines the fluid alignment of the fluid exchange device at the start of the exchange procedure after which the locking mechanism is activated to maintain fluid flow alignment after the boost pump is activated.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is a schematic view of a fluid exchange system according to the present invention

FIG. 2 is a schematic view of the automatic fluid-aligning valve assembly and the locking mechanism of FIG. 1.

FIG. 3 is an exploded view of the integral parts of the automatic flow alignment structure and locking mechanism of FIGS. 1, 2, 4 and 5.

FIG. 4 is a schematic view of the automatic fluid alignment structure and its attached locking mechanism of FIG. 2 and shows the automatic fluid alignment structure in its initial unlocked condition as proper fluid flow alignment in the process of being attained.

FIG. 5 is a schematic view of the automatic fluid alignment structure with locking mechanism operating in a properly aligned and locked condition, thus maintaining proper flow alignment while the fluid pump arranged to its used fluid conduit is operated to assist the exchange of fluids of a low flow hydraulic circuit or to speed up the fluid exchange.

FIG. 6 is a schematic view of an alternative embodiment of an automatic fluid-alignment valve assembly with more than one locking mechanism operating in a properly aligned and locked condition.

### DETAILED DESCRIPTION OF THE INVENTION

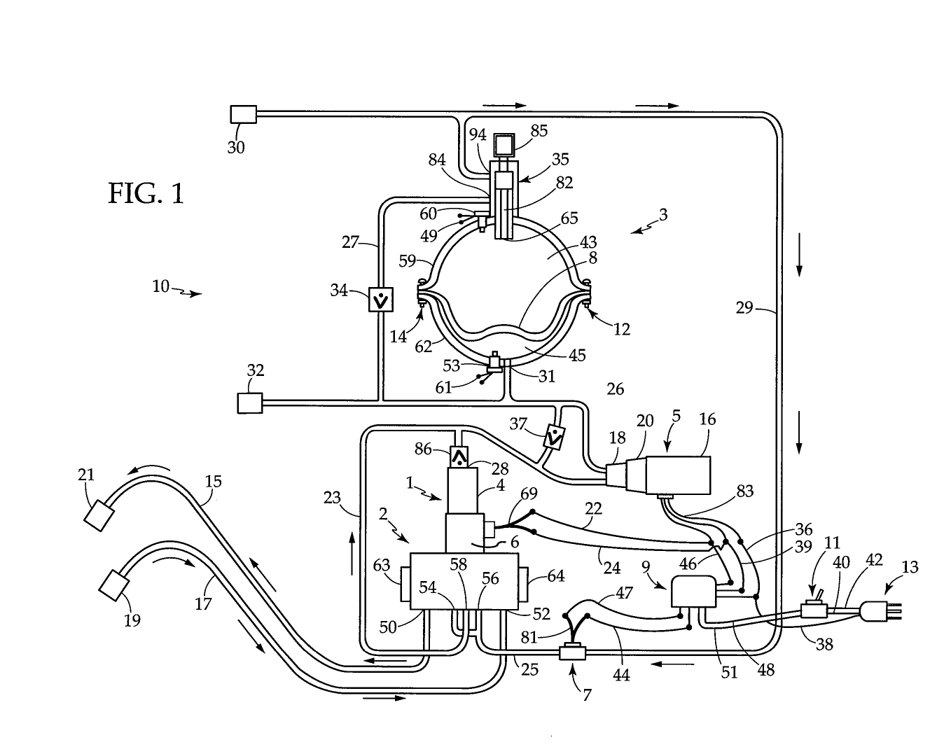

Referring now to the drawings, where like numerals represent like parts throughout, FIG. 1 is a schematic view of fluid exchange system 10 having an automatic flow-aligning valve assembly 2 and locking mechanism 1. A fluid exchanger, in this embodiment, diaphragm tank 3, is utilized during an exchange procedure to receive used fluid from an accessed hydraulic system and provide fresh fluid to the hydraulic system. Diaphragm tank 3 provides for a substantially equivalent exchange rate, i.e., the flow rate of used fluid extracted from the hydraulic system is about the same as the flow rate of new fluid introduced into the hydraulic system. Additional features of diaphragm tank 3 as well as alternative fluid exchangers are found in applicant's U.S. Pat. Nos. 5,318,080, 6,082,416, 6,164,346, 6,223,790, 5,267,160, 6,378,657, 6,446,682, 6,779,633, 6,962,175, each being incorporated by reference herein. As a result, a variety of different fluid exchanger may be utilized with flow-aligning valve assembly 2 and locking mechanism 1 in accordance with the present invention. For example, a moveable piston with seals inside a fixed volume cylinder, with the piston separating variable volume but reciprocally interdependent fresh and used fluid chambers is another type of used fluid and fresh fluid flow balancing structure that can be substituted for diaphragm tank assembly 3.

Fluid exchange system 10 includes a pair of fluid exchange conduits 15, 17 which are respectively connected at one end to quick connect 21 and quick connect 19, and at the other end to port 50 and port 52 of the automatic flow-aligning valve assembly 2.

Prior to the exchange procedure, quick connect 19 and quick connect 21 are selectively connected to an opened fluid circulation circuit of the hydraulic system. A fluid exchange system may be accessed by way of adapters connected to the opened fluid circulation circuit. For example, the cooling circuits of a variety of different automatic transmissions may be accessed with quick connects 19, 21 and an adapter kit (not shown, but well understood in the art).

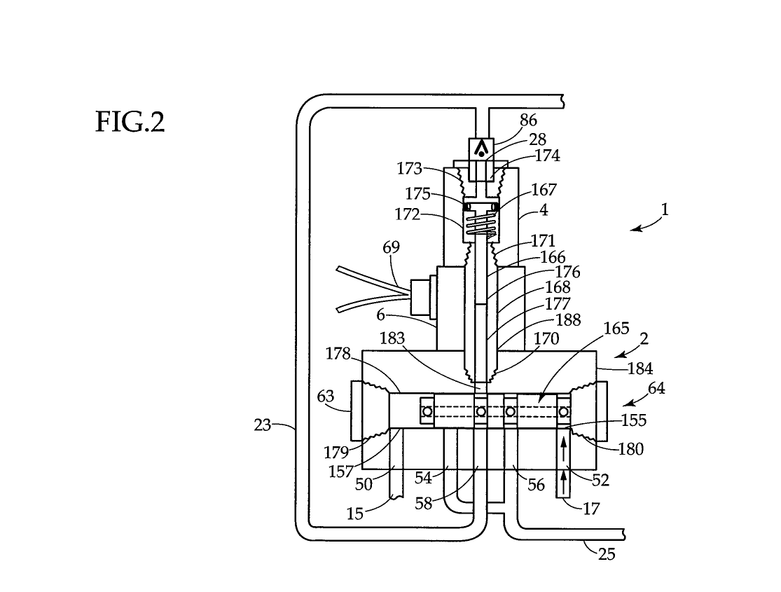

Automatic flow-aligning valve assembly 2 is operatively connected to locking mechanism 1. Locking mechanism 1 has solenoid coil 6 that is energized by 120 volts AC electrical current supplied by relay 9. An AC plug 13 has ground wire 38 that is connected to relay 9 and to ground wire 36 that is in turn connected to boost pump 5 at one of a set of leads 83. Automatic flow-aligning valve assembly 2 has hex plug 63 and hex plug 69 which seals and blocks, at either end, valve bore 178 (shown in FIGS. 2, 3, 4 and 5). Locking mechanism 1 may include other mechanical and/or electro-mechanical devices operatively connected to flow-aligning valve assembly 2 in order to lock a component or assembly within flow-aligning valve assembly 2 in a selected position during a fluid exchange procedure.

Locking mechanism 1 is fresh fluid controlled and allows the automatic flow-aligning valve assembly to be interconnected into the two fluid exchange hoses at any point, even close to the ends of the hoses where they are connected to the opened hydraulic circuit being serviced. This allows automatic flow-aligning valve assembly 2 and locking mechanism 1 to be sold as an aftermarket item to be easily retrofitted to any fluid exchanger which does not have an integral automatic flow alignment valve and which has a pair of fluid exchange hoses with one being a used fluid discharge hose and the other being a fresh fluid delivery hose.

Locking mechanism 1 has an operator rod containment assembly 4, which contains an internal operator rod assembly 166 (shown in FIGS. 2, 3, 4 and 5). Operator rod containment assembly 4 has balance port 28 to which check valve 86 is connected, which in turn is connected to used fluid conduit 23. Used fluid conduit 23 is connected at another one of its ends to used fluid outlet port 58 of automatic flow alignment valve 2, connected at another one of its ends to check valve 37, and connected at another of its ends to pump head 18.

Locking mechanism 1 is electrically operated. Referring to FIG. 1, hot wire 48 is connected at one end to relay 9 and at the other end to an on-off toggle switch 11. Neutral wire 51 is connected at one end to relay 9 and at the other end to toggle switch 11. Hot wire 42 is connected at one end to AC plug 13 and at its other end to on-off toggle switch 11. Hot wire 46 is connected at one end to one of the set of leads 83 of boost pump 5, at another end to relay 9, and also to hot wire 22. Neutral wire 40 is connected at one end to AC plug 13 and at its other end to on-off toggle switch 11. Hot wire 22 is connected to one of a pair of leads 69 of solenoid coil 6 at one end and at its other end to hot wire 46 that is connected at one end to relay 9 and at another end to one of a set of leads 83 of boost pump 5. Hot wire 24 is connected at one end to one of the pair of leads 69 of solenoid coil 6 and at its other end to neutral wire 39 which is connected at one end to one of the set of leads 83 of boost pump 5 and at its other end to relay 9. Signal wire 44 is connected at one end to one of a pair of leads 81 of flow switch 7 and at its other end to relay 9. Signal wire 47 is connected at one end to one of the pair of leads 81 of flow switch 7 and at its other end to relay 9.

Boost pump 5 in this embodiment is vane pump having pump head 18, which is powered by pump motor 16 at 120 volts AC. Pump motor 16 is connected to pump head 18 by pump coupler assembly 20. Pump head 18 contains a set of rotating vanes (not shown but understood in the art). Of course many other types of pumps can be substituted and would work equivalently. In this preferred embodiment boost pump 5 is a rotary vane pump, such as manufactured by Tuthill Corporation, Pump Model No. P11347 and disclosed in U.S. Patent Pub. No. 2005/0214153 to Citro et al., incorporated by reference herein.

Used fluid conduit 23 connects used fluid outlet port 58 of automatic flow-aligning valve assembly 2 with check valve 37, with pump head 18, and with check valve 86 which is connected to balance port 28 of operator rod containment assembly 4 within locking mechanism 1. Operator rod containment assembly 4 contains an operator rod assembly 166 (as shown in FIGS. 2,3,4,5). Fresh fluid conduit 25 connects fresh fluid inlet port 54 and fresh fluid inlet port 56 to flow switch 7.

Fresh fluid conduit 29 connects fresh fluid fill port quick connect 30 to bypass valve 35 at port 94 and to flow switch 7. Bypass valve 35 has male threads at its base (not shown) and is sealably connected with a nitrile type O-ring type seal to an opening at a top female threaded orifice (not shown) of top tank half 59 of diaphragm tank assembly 3 which also has bottom tank half 62.

Used fluid conduit 26 connects pump head 18 to check valve 37, to used fluid port 31 of bottom tank half 62, to bypass check valve 34, and to used fluid discharge port quick connect 32. Bypass conduit 27 is connected at one end to bypass check valve 34 and at its other end to bypass valve 35.

Diaphragm tank assembly 3 is comprised of displaceable diaphragm 8 enclosed inside top tank half 59 and bottom tank half 62, and secured to be fluid tight by a set of 24 identical fastener assemblies of which a connecting bolt/washer/nut assembly 12 and a connecting bolt/washer/nut assemblies 14 comprise two of the 24 identical fastener assemblies.

Bypass valve 35 contains bypass valve slide 65, which has an internal passage 82 with side port 84 that allows bypass conduit 27 connection to internal passage 82 when diaphragm 8 displaces bypass valve slide 65, moving it upward to attain a bypass mode of operation for the fluid exchanger which is characterized by establishing fluid communication between flexible fluid exchange conduits 15 and 17 via bypass conduit 27 through check valve 34, which removes the diaphragm tank assembly 3 from the fluid flow into and out of the hydraulic system being serviced.

Diaphragm 8 divides the interior of the diaphragm tank assembly 3 into fresh fluid chamber 43 and used fluid chamber 45. Bypass valve 35 has an automatic air vent 85 connected to it. Automatic air vent 85 bleeds off air unintendedly entering chamber 43 without leaking fluid from fresh fluid chamber 43. A bypass valve of the same design was disclosed in U.S. Pat. Nos. 6,082,416 and 6,267,160, each to Viken and each being incorporated by reference herein.

Tank top half 59 has position sensor 49 with a pair of leads 60 which are connected in series to a red indicator light, a warning tone, and a source of electric current (not shown but disclosed in U.S. Pat. No. 6,082,416 to Viken) such that when diaphragm 8 reaches its uppermost position conforming to tank top half 59 it activates the position sensor 49 and turns on the red indicator light and warning tone indicating to the operator that diaphragm tank assembly 3 is essentially filled with used fluid.

Tank bottom half 62 has position sensor 53 with pair of leads 61 which are connected in series to a green indicator light and a source of electric current (not shown but disclosed in U.S. Pat. No. 6,082,416 to Viken) such that when diaphragm 8 reaches its lowermost position conforming to tank bottom half 62, it activates the position sensor 53 and turns on the green indicator light and indicates to the operator that the diaphragm tank assembly 3 is essentially filled with fresh fluid.

A number of different rubber compounds can be used to construct diaphragm 8. Such compounds should be resistant to the effects of the particular hydraulic fluids that the fluid exchanger will be handling during the fluid exchanges. There are a number of different methods of constructing diaphragms, including molding with or without an integral reinforcing fabric. In the present invention diaphragm 8 is molded without any integral reinforcing fabric and is comprised of a nitrile-type compound.

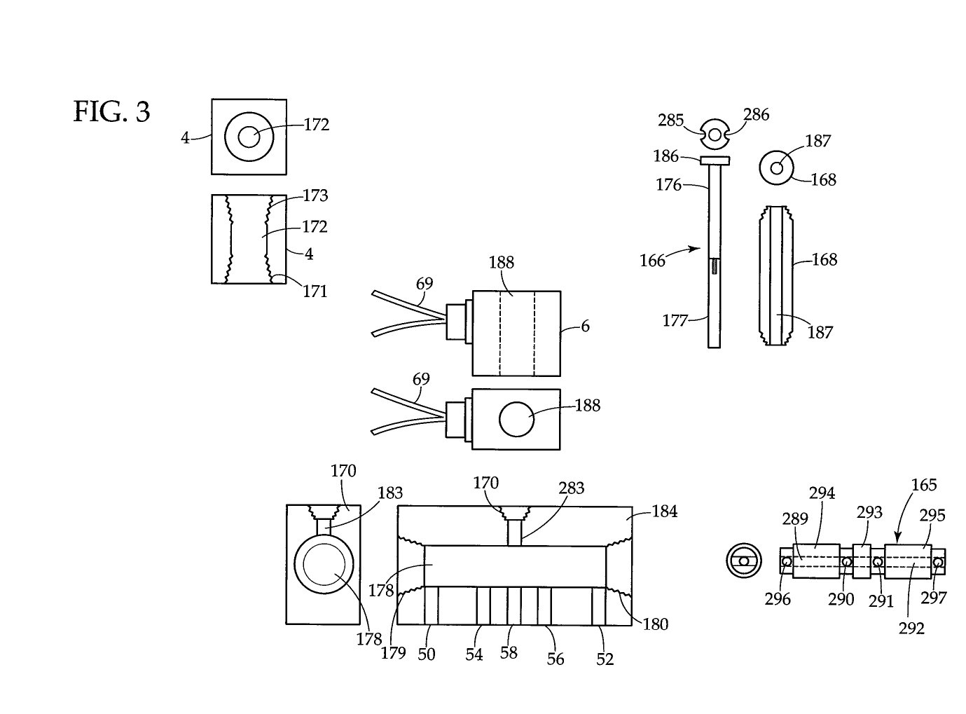

FIG. 2 is a schematic view of the automatic flow alignment valve 2 operating in an initial random, but non-aligned, not-locked mode of operation, characterized by valve 165 being position in a non-aligned position relative to the flow of used fluid being discharged from the hydraulic circuit accessed for fluid exchange. FIG. 3 is an exploded view of the integral parts of the automatic flow-aligning valve assembly 2 and locking mechanism 1. Automatic flow-aligning valve assembly 2 includes multi-port valve body 184 containing movable valve 165.

A valve slide 165 is contained within valve bore 178 of automatic flow-aligning valve assembly 2. Valve bore 178 is threaded at each end to receive hydraulic hex plug 63 at its leftmost end and hex plug 64 at its rightmost end, both in this case being fitted with an integral O-ring for suitable sealing (not shown). FIG. 3 shows valve slide 165 having left internal fluid passage 289 which has one end near the left side of valve slide 165 at left transverse cutout 296 and terminates at an end near right transverse fluid port 290 which is located between left land 294 and center land 293. FIG. 3 shows valve slide 165 to be constructed to have right internal fluid passage 292 which starts at the right side of valve slide 165 at right transverse cutout 297 and terminates at left transverse fluid port 291 which is located between right land 295 and center land 293. Left internal fluid passage 289 is not connected to the right internal fluid passage 292, and therefore no fluid can pass through either passage to the other (as shown in FIG. 2). Valve bore 178 has left chamber 157 which is between hex plug 63 and valve slide assembly 165, and has right chamber 155 which is between hex plug 64 and valve slide assembly 165.

As shown in FIG. 2, locking mechanism 1 has an operating rod containment tube 168 which is in this case constructed of an essentially magnetic neutral metal, brass in this instance. Various types of plastics and other essentially non-magnetic materials could be alternatively used. Operating rod containment tube is inserted through an internal bore 188 of solenoid coil 6 which has a suitably sized male threads at both ends, with the one at its lower end screwed into threaded port 171 of operator rod containment assembly 4 at one end and suitably sealed, with an anaerobic hydraulic sealer used in this case. At its other end operating rod containment tube 168 is screwed into threaded port 170 of valve body 184 of automatic flow alignment valve 2 and suitably sealed, with an anaerobic hydraulic sealer.

Operator rod containment assembly 4 has female threaded port 173 to which check valve 86, which has a male thread at one end, is screwed into busing 174, and busing 174 is then turned into threaded port 173 of operator rod containment assembly 4. Solenoid coil 6 has an internal passage 188 through which operator rod containment tube 168 can be inserted (FIG. 3). Rod operator assembly 166 is comprised of two integral parts which are counter threaded at their meeting ends for easy assembly, with an operator rod top half 176 and an operator rod bottom half 177 (as shown in FIG. 2). Rod operator assembly 166 (shown in exploded view in FIG. 3), has top crown 175 which has vent 285 and vent 286 cutout of it on either side, allowing any fluid pressure differential on either side of top crown 175 to be quickly vented and equalized. Operator rod top half 176 is constructed of a magnetic material, such as iron. Operator rod bottom half 177 is constructed of a non-magnetic material, such as brass.

In addition, locking mechanism 1 as shown in FIG. 2 can incorporate an interiorly placed diaphragm seal constructed of a nitrile type compound. This seal can be placed above operator rod crown 175 inside operator rod containment assembly 4. This diaphragm seal when arranged above rod operator assembly 166 inside rod operator containment assembly 4 and fresh fluid conduit 25, will allow fresh fluid delivered from fresh fluid chamber 43 to actuate the locking mechanism and keep it locked during the fluid exchange, as long as all the fresh fluid being conducted to the automatic flow-aligning valve assembly 2 passes into the top of operator rod containment assembly 4 on the way to the automatic flow-aligning valve assembly 2 and can only pass through it if the rod operator assembly of FIG. 2 moves into and remains in its locked position. This allows automatic flow-aligning valve assembly 2 with such a modified fresh fluid operated locking mechanism to be easily interconnected into the two fluid exchange hoses of any fluid exchanger which has a pair of fluid exchange hoses, one of which is a fresh fluid delivery hose and the other of which is a used fluid discharge hose, transforming the points at which each hose is connected to opened hydraulic circuit being serviced to become bi-directional fluid exchange hoses. This transformation of each of the fluid exchange hoses to bi-directional capability allows each to serve as a fresh fluid supply hose or a used fluid discharge hose for the hydraulic circuit, as will be determined by the direction of fluid flow in the hydraulic service being connected to for service, which is typically unknown at the time at which that circuit is opened and the hoses are connected (one each) to a side of the opened hydraulic circuit to be serviced.

FIG. 3 shows operator rod containment tube 168 having internal bore 187 to which rod operator assembly 166 is inserted and fits relatively loosely, able to easily slide up and down within the bore, allowing fluid pressure to quickly dissipate between the internal bore 187 and rod operator assembly 166.

Referring to FIG. 2, valve body 184 has an internal rod port 183 which allows the operator rod bottom half 177 to slide within and through to fit between either pair of lands of valve slide assembly 165, center land 293 and right 295, or between center land 293 and left land 294, depending on whether valve slide 165 is in its leftmost or rightmost position respectively. Operator rod bottom half 177 can be moved into its locked position located between either of these sets of lands under power of the solenoid coil 6 when it is provided electrical current and draws the operator rod top half 176 downward, under power of the magnetic force provided by solenoid coil 6. During assembly, operator rod assembly 166 is inserted through return spring 167, into and through an internal cavity 172 of rod operator containment assembly 4, and into and through operator rod containment tube 168. Rod operator assembly 166 can move back into its unlocked position when electrical current is removed from solenoid coil 6, which results when flow switch 7 stops providing signal to relay 9 to provide current to solenoid coil 6. When current is removed from solenoid coil 6, return spring 167 moves operator rod assembly 166 back into its unlocked position. Alternatively, for some low pressure hydraulic circuits, if locking mechanism 1 is positioned on the bottom side of automatic flow-aligning valve assembly 2, return spring 167 can be eliminated, with gravity providing the power to move rod operator assembly 166 back into position.

FIG. 3 shows valve body 184 to have five ports machined to its bottom side which penetrate from the outside into valve bore 178, and these include port 50 and port 52 to which flexible fluid exchange hoses 15 and 17 of FIG. 1 are connected respectively. Fresh fluid port 54 and fresh fluid port 56 are both connected to fresh fluid conduit 25 of FIG. 1. Used fluid outlet port 58 is connected to used fluid conduit 23 of FIGS. 1 and 2. These port connections are made using conventional sealing methods such as inserting threaded hose barbs into female threads cut into each port (not shown but known in the art), with the conduits and hoses then connected to the hose barbs by conventional means such as hose clamps or self-locking methods known in the art.

### OPERATION OF THE PREFERRED EMBODIMENT

The preferred embodiment of FIG. 1 is interconnected to the hydraulic fluid circuit that is to be serviced, which in this instance is a fluid cooling line of an automatic transmission (not shown, but understood in the art). The fluid cooling line is opened, establishing two ports or orifices, each of which will serve as a suitable connection point for one of the flexible fluid exchange conduits 15 and 17 which in this case are constructed of flexible rubber which is resistant to automatic transmission fluids. In this case as shown in FIG. 1, the particular connections made to these orifices are flexible fluid exchange conduit 17 connected to the higher pressure side (discharge side) of the cooling circuit of the automatic transmission, and flexible fluid exchange conduit 15 connected to the lower pressure side (return side) of the cooling circuit. In FIG. 1, fluid flow is represented by use of arrows. The fluid exchange system operator does not need to identify or know which of the two orifices provides access to either the lower pressure, return side of the cooling circuit, or the higher pressure, outlet side of the cooling circuit in order to operate the system and institute a fluid exchange procedure.

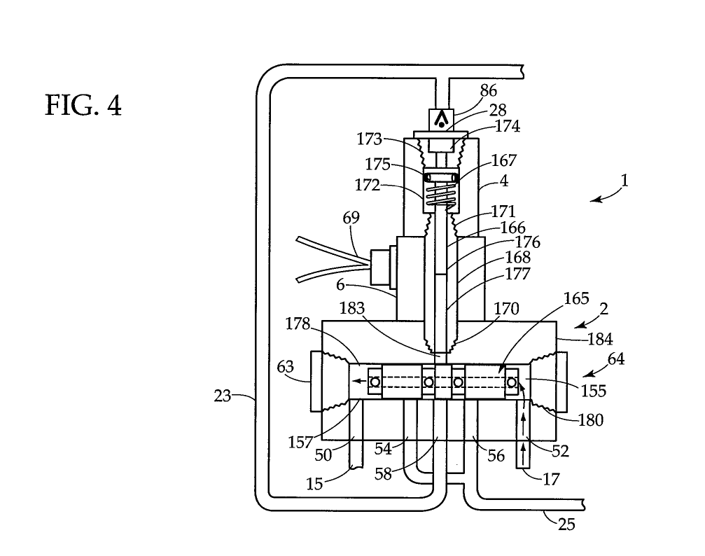

The fluid exchange system 10 aligns itself with the direction of fluid flow in the hydraulic circuit being serviced. As the engine of the vehicle is started and operated in park, neutral or drive (with the parking brake applied) the automatic transmission is rendered operative to flow fluid through its cooling circuit. This causes used fluid to be discharged into and through flexible fluid exchange conduit 17, then into right valve chamber 155 of the automatic flow-aligning valve assembly 2. Valve slide 165 begins to be moved toward and into the left chamber 157 of valve bore 178 as shown in FIG. 4, which depicts the operation of automatic flow-aligning valve assembly 2 in a transitional mode of operation before valve slide 165 has moved into proper flow alignment position. At the same time any pressure differential between used fluid outlet port 58 and the topside of operator rod crown 175 is equalized through check valve 86 and balance port 28 (FIG. 2).

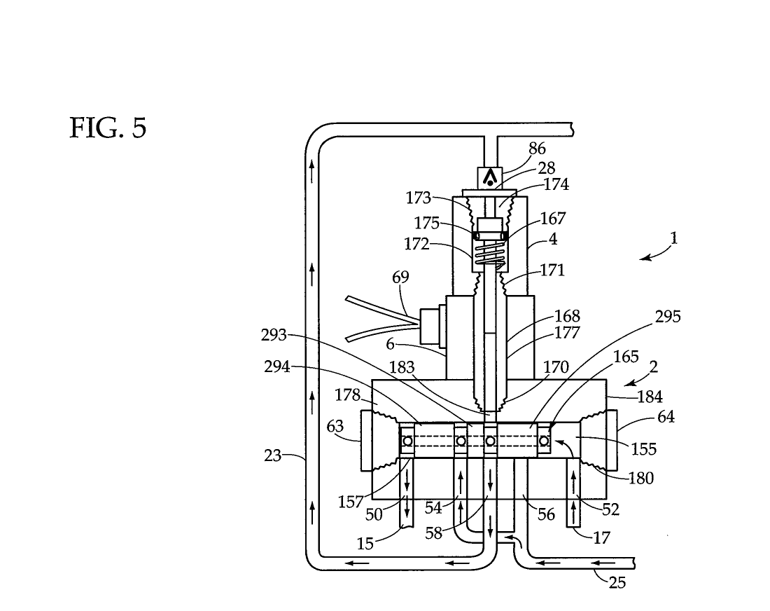

The fluid pressure provided by the accessed cooling circuit of the automatic transmission through flexible fluid exchange conduit 17 continues to move valve slide assembly 165 toward and into left chamber 157 until it can go no further, at which time valve slide 165 is properly aligned with the operator rod bottom half 177 as shown in FIG. 5. When valve slide 165 has become moved into its proper alignment position, used fluid flows from used fluid outlet port 58 into and through used fluid conduit 23, through check valve 37, then into port 31 of diaphragm tank assembly 3 to be deposited in used fluid chamber 45 (as shown in FIG. 1).

This causes used fluid chamber 45 to increase in volume, which causes diaphragm 8 to be displaced by the same volume, which then results in an essentially equivalent volume of fresh fluid being pumped out of fresh fluid chamber 43 into and through bypass valve slide 65 through its side port 94 and into and through fresh fluid conduit 29. Fresh fluid then flows through flow switch 7, through port 54 (FIG. 2), through left transverse fluid port 290, through left internal fluid passage 289, into left chamber 157, through port 50, and then into flexible fluid exchange conduit 15 to be delivered into the lower pressure side (return side) of the cooling circuit of the automatic transmission having its fluid exchanged.

When fluid begins to flow through flow switch 7, an electrical switch (not shown) closes and provides an electrical signal to relay 9 that activates to provide power to boost pump 5 and solenoid coil 6. As boost pump 5 is activated to pump fluid, solenoid coil 6 is energized to move rod operator assembly 166 (FIG. 2) downward into and through internal rod port 183 to rest between right land 295 and center land 293 (FIG. 5). The space between right land 295 and center land 293 is in proper position to receive rod operator assembly 166 because valve slide 165 has already moved into proper position before fluid flows through flow switch 7 to cause solenoid coil 6 to become energized and activate boost pump 5. As long as fluid continues flowing through flow switch 7, rod operator assembly 166 is held in position and blocks any movement of valve slide 165 which could occur due to the operation of boost pump 5, which could raise the fresh fluid pressure in left chamber 157 of automatic flow-aligning valve assembly 2 to be greater than the used fluid pressure at its right chamber 155.

Referring to FIG. 2, if the fluid pressure in left fluid chamber 157 is greater than the fluid pressure in right chamber 155, then valve slide 165 will move into its furthermost right position unless locking mechanism 1 has been operated to attain its properly locked position. Alternatively, if the fluid pressure in right fluid chamber 155 is greater than the fluid pressure in left fluid chamber 157, then the valve slide 165 will move into its furthermost left position. Once rod operator assembly 166 is pulled into and through internal rod port 183 and held there by force of energized solenoid coil 6, automatic flow-aligning valve assembly 2 is in locked position characterized by rod operator assembly 166 blocking any potential shift of valve slide 165 out of its proper alignment position. This proper alignment position is initially determined by the direction of fluid flow in the hydraulic circuit being serviced in relation to the particular random choice made by the operator for connecting the flexible fluid exchange conduits to the two orifices made available by opening the hydraulic circuit. In vehicular fluid exchanges, valve slide 166 moves into proper alignment position before used fluid flows out of automatic flow-aligning valve assembly 2 into used fluid conduit 23. In even those which involve higher flow transmissions which operate at much higher pressures, a delay in the activation of flow switch 7 would result from the wall flexibility of in the conduits of the present invention in its preferred embodiment because the flexible used and fresh fluid conduits 15 and 17 respectively are constructed of a nitrile based rubber hose which is resistant to automatic transmission fluid.

Conduit 15, 17 flexibility typically allows a small amount of wall expansion which can provide enough delay in the pressure increase in fresh fluid conduit 29 transmitted to port 54 of automatic flow-aligning valve assembly 2 for the solenoid coil 6 to move the operator rod assembly 166 downward to place the lowermost end of operator rod bottom half 177 into proper locked position before the boost pump is activated. This assures that the valve slide assembly 165 will stay in proper fluid flow alignment position when the boost pump is activated to increase the pressure of the fresh fluid to be greater than the pressure of the used fluid, which could increase the fresh fluid pressure in chamber 157 to be greater than the used fluid pressure of chamber 155 (FIG. 5) which would otherwise cause valve slide 165 to move towards its rightmost position.

If the internal fluid exchange conduits are constructed of a hard, non-expanding material such as steel or aluminum tubing, or the pressures of the hydraulic fluid circuit being serviced with a fluid exchange are relatively high, an electronic time delay relay can be used to delay the activation of locking mechanism 1 and boost pump 5 to assure that the valve slide 165 has reached its proper flow alignment position. For example, such electronic time delay relay can be interconnected to either signal wire 44, or to signal wire 47 of flow switch 7, or within relay 9, or to hot wire 46 of boost pump 5.

As shown in FIG. 5, valve slide 165 has moved into its left most position establishing fluid flow alignment. This direction to which valve slide 165 moves is based on the direction of fluid flow in the hydraulic fluid circuit being accessed in coordination with the particular selection of which flexible fluid exchange conduit 15 or 17 is connected to the higher pressure side of that circuit. In this case the operator has connected flexible fluid exchange conduit 17 to the higher pressure (discharge) side of that hydraulic circuit and flexible fluid exchange conduit 15 to the lower pressure (return) side of that circuit.

As shown in FIG. 5, once valve slide 165 has moved into its left most position, it has established fluid flow alignment, the used fluid will flow into the used fluid chamber 45 (FIG. 1), thus displacing an essentially equivalent amount of fresh fluid from fresh fluid chamber 43. Once this occurs, fresh fluid will flow into and through fresh fluid conduit 29 to flow through flow switch 7, thus activating flow switch 7 which results in providing an electrical signal to relay 9 which in turn provides current to energize solenoid coil 6 and to operate boost pump 5 as shown in FIG. 1. Referring to FIG. 5, as used fluid flows through port 58 and into used fluid conduit 23, it also exerts the same fluid pressure to internal rod port 183 of valve body 184, which could create a pressure differential on both sides of the rod operator assembly 166, with the higher pressure on its lower side, thus potentially keeping it in its upper most position. Any tendency for there to be a pressure differential impacting rod operator assembly 166 to keep it in its uppermost position is neutralized because this pressure differential has been dissipated and equalized through a venting system and check valve 86.

Referring to FIGS. 2 and 3, this venting system is comprised of the gap between the operator rod assembly 168 and the internal bore 187 of operator rod containment tube 168 and internal port 183, through the vents 285 and 286 of top crown 185 of rod operator assembly 166, through balance port 28, and through used fluid conduit 23. This venting system for rod operator assembly 166 makes it essentially pressure neutral, allowing it to move freely to lock valve slide 165 in automatic flow-aligning valve assembly 2 in its proper flow alignment position when solenoid coil 6 is energized, and to also able to return under the power of return spring 167 when electrical current is removed from solenoid coil 6 after the fluid stops flowing through the fluid exchange system which occurs when the when the operator turns off the engine of the vehicle (in a vehicular fluid exchange) or turns off the hydraulic supply pump (in other industrial hydraulic systems).

As shown in FIG. 1, when boost pump 5 is operated it can increase increases the fresh fluid pressure in fresh fluid conduit 29 to be greater than the fluid pressure of used fluid conduit 23 by applying lower pressure to the top side of check valve 86 than to used fluid out port 58. Because check valve 86 does not allow flow upward through it, any additional low pressure at the topside of check valve 86 prevents that additional low pressure to be communicated through it to urge rod operator assembly 166 upward.

It should be noted that in some lower pressure applications, use of the balance port 28 or any connection of operator rod containment assembly 4 to used fluid conduit 23 would not be required, since the remaining part of the venting system would be adequate to prevent enough used fluid pressure differential from diminishing the movement of rod operator assembly 166 when force is being applied to rod operator assembly 166 by solenoid coil 6.

Referring to FIG. 5, once valve slide 165 has moved into its left most position establishing fluid flow alignment and is locked into its proper flow alignment position by the energizing of solenoid coil 6 as shown in FIG. 5, used fluid flow into used fluid chamber 45 (FIG. 1) is boosted by boost pump 5 and system 10 is placed it its operational, fluid pumping mode. If the hydraulic system being serviced with a fluid exchange is a higher flow type system which pumps used fluid into used fluid conduit 23 at a higher flow rate than provided by boost pump 5, then used fluid flows through check valve 37 (FIG. 1), which prevents the fluid exchange from being slowed needlessly down. On the other hand, if the hydraulic system being serviced with a fluid exchange is a lower flow type system which pumps used fluid into used fluid conduit 23 at a flow rate less than provided by boost pump 5, then check valve 37 closes and prevents the used fluid provided by pump 5 from being bypassed back into used fluid conduit 23 and into pump head 18 of boost pump 5, which could slow or even potentially stop the fluid exchange.

Boost pump 5 in this depiction of FIG. 1 is arranged intermediate between used fluid conduit 23 and used fluid conduit 26, therefore before the used fluid enters used fluid port 31 of diaphragm tank assembly 3 to enter used fluid chamber 45, it either passes through check valve 37 or is pumped through boost pump 5. Alternatively boost pump 5 could be arranged intermediate to fresh fluid conduit 29. This would also function effectively.

Referring to FIG. 1 the fluid exchange system 10 will continue until the engine of the vehicle is turned off to render the automatic transmission inoperative, or until fresh fluid chamber 43 reaches its uppermost position in diaphragm tank assembly 3, at which time it moves bypass valve slide 65 into its upper position, which in turn positions internal passage 82 of bypass valve slide 65 to allow fluid to flow from used fluid conduit 26, through check valve 34 and into bypass conduit 27, through bypass valve 35 and into fresh fluid conduit 29. Thus, when bypass valve slide 65 is moved by diaphragm 8 into its upper most position, the fluid exchange system 10 is shifted into bypass mode, allowing the fluid being discharged from the hydraulic circuit to be immediately returned (without exchange) back into the inlet (return) side of the hydraulic system. This feature allows the operator of the fluid exchange system freedom of movement away from the vehicle during the exchange procedure without fear of vehicle damage. In addition, when diaphragm 8 reaches its uppermost position, it activates position switch 49 which then energizes a red LED and warning tone which notify the operator that the fresh fluid supply of fresh fluid chamber 43 is depleted and the fluid exchange system is in bypass mode.

Before another fluid exchange is instituted for another hydraulic system, the operator should determine which type of new fluid should be used to fill fresh fluid chamber 43. In this example, another vehicle with an automatic transmission with a circulating hydraulic fluid system, an external cooling circuit. In order to fill fresh fluid chamber 43, diaphragm tank assembly 3 must be recharged, which involves the pumping of fresh fluid into fresh fluid fill port quick connect 30 accompanied by the simultaneous venting into a waste receiver of the used fluid of used fluid chamber 45 through used fluid discharge port quick connect 32.

During the recharging of diaphragm tank assembly 3, the volume of the used fluid being discharged is essentially equivalent to the volume of fresh fluid being pumped in because it is being displaced by the fresh fluid being pumped into chamber 43. As fresh fluid is pumped into fresh fluid fill port quick connect 30, it flows into the top of bypass valve 35 and through bypass valve slide 65 to enter fresh fluid chamber 43. Check valve 34 provided to bypass conduit 27 prevents fresh fluid from flowing out of used fluid discharge port quick connect 32 during the recharge.

This recharging of diaphragm tank assembly 3 can be instituted by the operator connecting a separate used fluid drain hose (not shown) to used fluid discharge port quick connect 32 which has its own compatible quick connect at that connection end and then placing its other end to discharge into a suitable waste receiver for proper disposal later. The operator also connects a pressurizable source of fresh fluid to with a quick connector compatible with fresh fluid fill port quick connect 30. Then the operator pumps fresh fluid from this fresh fluid source into fresh fluid fill port quick connect 30 while used fluid is simultaneously discharged. This recharging is continued until fresh fluid chamber 43 is full and used fluid chamber 45 is essentially emptied. A complete recharge is characterized as the movement of diaphragm 8 to its lowermost position possible in diaphragm tank assembly 3. When this lowermost position of diaphragm 8 is attained, then it activates position sensor 53 that in turn energizes a green LED, signaling the operator that the recharge procedure is complete and the unit is now ready to institute another fluid exchange procedure as soon as connections to fresh fluid fill port quick connect 30 and used fluid discharge port 32 are removed.

Alternatively, the used fluid position sensor 53 can be used to provide a signal to relay 9 to control current to operate boost pump 5 as soon as diaphragm 8 is moved slightly upward from its most downward position, with the fresh fluid position sensor 49 used to provide signal to relay 9 to remove the current to boost pump 5.

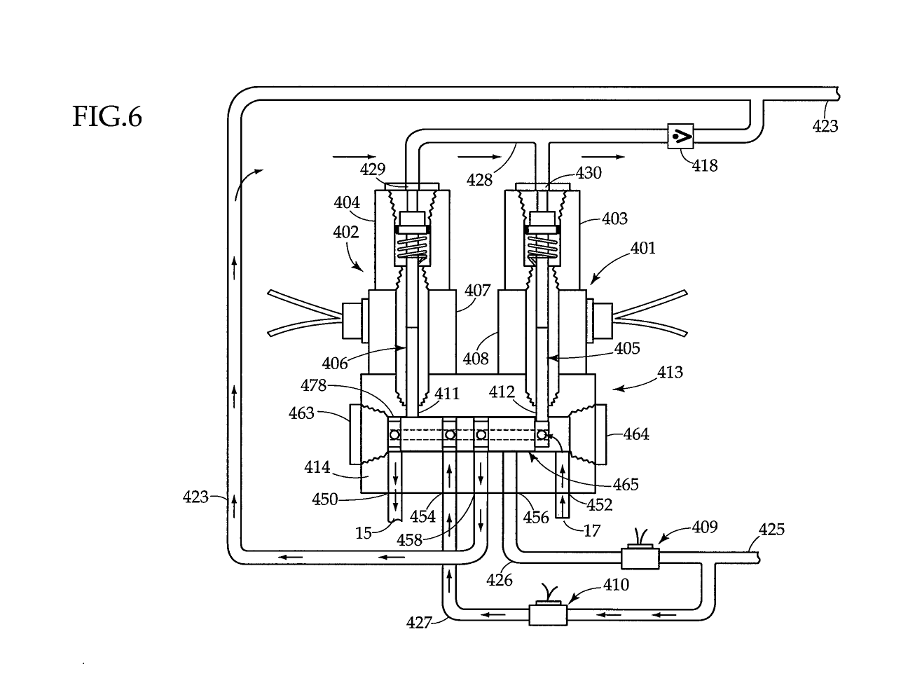

FIG. 6 shows an alternative form of an automatic flow alignment valve 413 with dual locking mechanisms connected to valve block 414. This form can be substituted for the preferred form shown in FIGS. 1-5 and used in almost any other fluid exchange system which utilized electrical current and has two flexible fluid exchange conduits, one for dispensing fresh fluid to the hydraulic circuit having a fluid exchange and the other one for receiving used fluid from that hydraulic circuit. Two separate locking mechanisms, right locking mechanism 401 and left locking mechanism 402 are connected to automatic flow alignment valve 413. Both locking mechanism 401 and locking mechanism 402 are internally configured the same as the locking mechanism 1 as shown in FIGS. 1-5, operate according to the same principles, and are arranged on valve block 414 as shown in FIG. 6.

Locking mechanisms 401 and 402 each contain a rod operator assembly, rod operator assembly 405 and rod operator assembly 406 respectively. Used fluid discharged from the hydraulic circuit being serviced is flowing through flexible fluid exchange conduit 17 (shown in FIG. 1) and into port 452 of valve block 414 and has already moved valve slide 465 into proper flow alignment position after which used fluid flows out of port 458. Fresh fluid is flowing from fresh fluid conduit 425 through flow switch 410, through fresh fluid conduit 427, into fresh fluid inlet port 454 of valve block 414, and out of port 450 and into flexible fluid exchange conduit 15 (shown in FIG. 1). Valve block 414 has an internal bore 478 which has hex plugs 463 and 464 screwed into each of its ends which are provided with suitably matched female threads. Bore 478 has two internal access ports, ports 411 and port 412 provided which allow rod operator assemblies 405 and 406 respectively to intersect and lock valve slide 465 when either one is moved downward by activation of their corresponding solenoid coils 407 or 408 respectively.

Flow switch 410 has been activated by the fresh fluid flowing through it and has triggered relay 9 (FIG. 1) which in turn has provided current to boost pump 5 (FIG. 1) and to both solenoid coils 407 and 408. Only rod operator assembly 405 can move downward into position since valve slide 465 blocks complete extension downward of rod operator assembly 406. The downward movement of rod operator assembly 405 into proper locked position will prevent valve slide 465 from moving to its right if the boost pump 5 increases the fresh fluid pressure in fresh fluid conduit 425 to be greater than the pressure in used fluid conduit 423 at automatic alignment valve 413.

A balance conduit 428 is connected at one end to check valve 418, and at another end to balance port 429 of an operator rod containment assembly 404 of locking mechanism 402, and also connected at another end to balance port 430 of an operator rod containment assembly 403 of locking mechanism 401.

In FIG. 6, there are two separate flow switches, flow switch 409 and flow switch 410. Flow switch 409 is connected at one end to fresh fluid conduit 426 that is in turn connected to fresh fluid inlet port 456, and at its other end to fresh fluid conduit 425. Flow switch 410 is connected at one end to fresh fluid conduit 427 that is in turn connected to fresh fluid inlet port 454, and at its other end to fresh fluid conduit 425. When this automatic flow alignment valve 413 with dual locking mechanisms 401 and 402 and dual flow switches 409 and 410 is substituted for automatic flow alignment valve 2 with locking mechanism 1 and flow switch 7 of FIG. 1, fresh fluid conduit 425 of FIG. 6 is connected to fresh fluid conduit 29 of FIG. 1, and balance conduit 428 is connected to check valve 418 at one end, to balance port 429 at an other end, and balance port 430 at another end.

Additional forms using other multiple fluid flow valves configured to provide automatic alignment can be fitted with associated multiple locking devices can be utilized and do not depart from this novel art. The locking mechanisms can be configured to operate from the power provided by fresh fluid or by power of an electric solenoid coil in combination with an electric flow switch and relay. For example, an automatic fluid flow alignment structure comprised of 4 separate check valves such as disclosed in U.S. Pat. No. 5,806,629 to Dixon et al, or an automatic fluid flow alignment structure comprised of a shuttle valve and two check valves such as disclosed in U.S. Pat. No. 6,267,160 to Viken, can have each valve provided with a locking device.

Pairs of check valves can utilize combination locking mechanisms based on the locking mechanism herein disclosed can be arranged and sealed between two check valves each, able to lock one when activated, and locking the other in default. These pairs of check valves then can share a single locking mechanism with a two sided operator rod assembly, which is operated in a first direction by default under spring power, and can operate in the opposite direction under power provided by the solenoid coil after a signal is generated to direct the proper operation of such combination locking device. This allows the use of a boost pump to pump the fresh fluid at a higher pressure than the incoming used fluid from the accessed hydraulic circuit, which would otherwise disrupt the function of the automatic flow alignment valve structure.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A fluid exchanging device for exchanging used fluid in a hydraulic system, said fluid exchange device comprising:
at least one valve body having a pair of fluid exchange ports, with said exchange ports conducting therethrough used fluid from the hydraulic system toward the valve body and fresh fluid toward the hydraulic system;
a valve within said valve body and movable between a first position and second position, wherein when said valve is in the first position one of said pair of exchange ports conducts used fluid toward a used fluid receiver and said other exchange port conducts fresh fluid from a fresh fluid reservoir toward the hydraulic system, and when said valve is in the second position said one of said pair of exchange ports conducts fresh fluid from the fresh fluid reservoir toward the hydraulic system and said other exchange port conducts used fluid from the hydraulic system toward the used fluid reservoir; and
a locking mechanism operatively coupled to said valve body and selectively locking said valve in either said first position or second position.

2. The fluid exchange device of claim 1 further comprising:
a boost pump interconnected to either a used fluid conduit or a fresh fluid conduit.

3. The fluid exchange device of claim 1 wherein the valve moves in response to a pressure differential provided by said hydraulic system.

4. The fluid exchange device of claim 1 wherein the locking mechanism is an electromechanical device.

5. The fluid exchange device of claim 4 wherein the locking mechanism comprises an electric solenoid.

6. The fluid exchange device of claim 5 wherein the electric solenoid is controlled in response to a sensed flow.

7. The fluid exchange device of claim 6 wherein the sensed flow is provided by a flow sensor in fluid communication with the valve body.

8. The fluid exchange device of claim 5 wherein a boost pump is activated at the same time as the electric solenoid so that the valve remains locked in position while the boost pump is activated.

9. A fluid exchanging device for exchanging fluid in a hydraulic system comprising:
a multi-port valve assembly in fluid communication with the hydraulic system via a pair of flexible conduits, said hydraulic system being accessed via a pair of access ports, said valve assembly comprising a movable valve, with said valve being movable between a first position and second position to control directions of fluid flow through said pair of conduits, said valve being movable in response to a fluid pressure, wherein regardless of how the pair of conduits are coupled to the pair of access ports the valve controls used fluid to flow out of one of the access ports and controls fresh fluid to flow into the other access port; and
a locking mechanism which, upon activation, secures said valve in either the first position or second position during a portion of a fluid exchange.

10. The fluid exchange device of claim 9 wherein the locking mechanism comprises an electromechanical device.

11. The fluid exchange device of claim 10 wherein the locking mechanism comprises an electrically operated solenoid.

12. The fluid exchange device of claim 11 wherein the solenoid moves a rod to engage and lock the valve in either the first position or second position.

13. The fluid exchange device of claim 12 wherein the locking mechanism is activated while a boost pump is activated, said boost pump increasing pressure within one or more conduits of the device.

14. The fluid exchange device of claim 13 wherein the locking mechanism release the valve after the boost pump is deactivated.

15. A fluid exchange device comprising:
a multiport valve assembly in fluid communication with a hydraulic system via a pair of flexible conduits, said hydraulic system being accessed via a pair of access ports, said valve assembly comprising a movable valve, with said valve being movable between a first position and second position to control directions of fluid flow within the device;
a boost pump in fluid communication with said valve assembly, said boost pump increasing a flow of fluid through said device when selectively activated; and
a lock component which moves relative to the valve, and when activated said lock component engages and locks said valve in either the first position or second position during at least a portion of an exchange procedure.

16. The device of claim 15 wherein the lock component is activated while the boost pump is activated, and deactivated when the boost pump is deactivated.

17. The device of claim 15 further comprising a wire coil that when energized causes the lock component to move.

18. The device of claim 17 further comprising a spring tending to bias the lock component away from engagement with the valve.

19. A method of exchanging fluid using the device of claim 15 comprising:
coupling the pair of flexible conduits to the pair of access ports without regard to internal flow of the hydraulic system;
flowing used fluid into the device from the hydraulic system, said flow causing the valve to move to either the first position or the second position;
activating the lock component to move into engagement with the valve and lock the valve in place; and
activating the boost pump to increase a flow of used fluid or fresh fluid through said device while the lock component is activated.

20. The method of claim 19 wherein used fluid and fresh fluid of the hydraulic system are exchanged at an approximately equivalent rate.
